(19) United States
(12) Patent Application Publication
(10) Pub. No.: US 2012/0113543 A1
(43) Pub. Date: May 10, 2012

(54) MAGNETIC HEAD AND MAGNETIC RECORDING/REPRODUCTION APPARATUS USING THE SAME

(75) Inventors: Masato Shiimoto, Odawara (JP); Mikito Sugiyama, Odawara (JP)

(73) Assignee: HITACHI, LTD., Tokyo (JP)

(21) Appl. No.: 13/291,580

(22) Filed: Nov. 8, 2011

(30) Foreign Application Priority Data
Nov. 10, 2010 (JP) 2010-252037

(51) Int. Cl. G11B 5/17; G11B 21/02

(52) U.S. Cl. 360/75; 360/123.03; G9B/5.05; G9B/21.003

(57) ABSTRACT

A magnetic recording head enabling both enhancement of a strength of a magnetic field from a main pole and provision of narrow-track recording to achieve a high recording density in a high-frequency magnetic field-assisted recording method is provided. An oscillator 110 that generates a high-frequency magnetic field is provided on the trailing side of a main pole 120, and viewed from the air bearing surface side, a ratio Pw/Two between a track width Pw of a trailing-side edge portion of the main pole and a track width Two of a leading-side edge portion of the oscillator is no less than 0.85 and no more than 1.25, and the main pole includes a part having a track width larger than Pw between the trailing-side edge portion and a leading-side edge portion of the main pole.

### CLAIM OF PRIORITY

The present application claims priority from Japanese patent application JP 2010-252037 filed on Nov. 10, 2010, the content of which is hereby incorporated by reference into this application.

### BACKGROUND OF THE INVENTION

1. Field of the Invention

The present invention relates to a magnetic head having a function that applies a high-frequency magnetic field to a magnetic recording medium to induce a magnetization reversal, and a magnetic recording/reproduction apparatus including the same.

2. Background Art

In recent years, there has been a demand for a rapid increase in recording density of magnetic recording/reproduction apparatuses such as hard disk drives (HDDs) at an anural rate of around 40%, and it is expected that an areal recording density of 1 Tbits/inch² is achieved in around 2012. An increase in areal recording density requires miniaturization of a magnetic recording head and a reproduction head as well as reduction in size of magnetic grains in a magnetic recording medium. However, miniaturization of a magnetic recording head results in a decrease in recording magnetic field strength, and thus, the problem of recording performance insufficiency can be expected to occur. Furthermore, reduction in size of magnetic grains included in a magnetic recording medium results in emergence of the problem of heat fluctuation, and thus, it is necessary to increase the coercive force and the anisotropic energy along with provision of the reduction in size of magnetic gains, resulting in difficulty in recording. Accordingly, recording performance enhancement is the key for an areal recording density increase. Therefore, assisted recording in which the coercive force of a magnetic recording medium is temporarily decreased only during recording by means of application of heat or a high-frequency magnetic field has been proposed.

Meanwhile, an assisted recording method using high-frequency magnetic field application, called “microwave-assisted magnetic recording (MAMR)”, has recently been drawing attention. In MAMR, a strong high-frequency magnetic field in the microwave band is applied to an area in the order of nanometers to locally excite a recording medium, thereby reducing a reversed magnetic field to record information. Because of use of magnetic resonance, a large effect cannot be provided in reducing a reversed magnetic field without a high-frequency magnetic field having a high frequency proportional to an anisotropic magnetic field of a recording medium. JP Patent Publication (Kokai) No. 2005-025831 discloses a high-frequency oscillator for generating a high-frequency assist magnetic field, the high-frequency oscillator having a structure in which a film stack with a structure similar to that of a giant magneto-resistance (GMR) effect element is sandwiched by electrodes. A high-frequency oscillator can generate a minute high-frequency oscillating magnetic field by injecting conduction electrons having spin fluctuation, which are generated in a GMR structure, into a magnetic material via a nonmagnetic material. “Microwave Assisted Magnetic Recording” (J-G. Zhu et. al., IEEE trans. Magn., Vol. 44, No. 1, pp. 125 (2008)) discloses a technique in which a high-frequency magnetic field generation layer (hereinafter, abbreviated as “FGL”) that rotates at high speed by means of spin torque is arranged adjacent to a main pole of a vertical magnetic head to generate microwave (high-frequency magnetic field), thereby recording information on a magnetic recording medium having large magnetic anisotropy. Furthermore, “Media damping constant and performance characteristics in microwave assisted magnetic recording with circular as field” (Y. Wang et al., Journal of Applied Physics, Vol. 105, pp. 07B902 (2009)) discloses a technique in which an oscillator is arranged between a main pole of a magnetic recording head and a trailing shield behind the main pole to change a direction of rotation of a high-frequency magnetic field according to the polarity of a recording magnetic field, thereby effectively assisting a magnetization reversal on a magnetic recording medium. “Media damping constant and performance characteristics in microwave assisted magnetic recording with circular as field” describes that using a MAMR head with a main pole having a track width larger than that of an oscillator, recording can be performed with a recording track width substantially equal to the width of the oscillator.

### SUMMARY OF THE INVENTION

In recent years, a recording density exceeding around 1 Tb/in² is demanded for magnetic recording, and in order to achieve such degree of recording density in MAMR, it is necessary to apply a strong high-frequency magnetic field to an area in the order of nanometers to make a magnetic recording medium locally enter a magnetic resonance state, thereby reducing a reversed magnetic field to record information. It has been reported that a recording density of no less than 1 Tb/in² can be provided using the technique disclosed in “Microwave Assisted Magnetic Recording” or “Media damping constant and performance characteristics in microwave assisted magnetic recording with circular as field”. It is also described that in these techniques, even if the track width of a recording head is larger than the width of an oscillator, the width of a magnetic track on which recording is actually performed is substantially equal to the width of the oscillator. In other words, MAMR is considered as having the advantage of providing a large recording magnetic field strength because a wide main pole can be used. The present inventors studied a possible degree of recording density increase provided by using the MAMR technique, by means of micromagnetic simulation. In this study, the present inventors focused their attention on the quality of recording signals and the width of magnetic tracks. Here, as the signal quality is better, a higher linear recording density can be provided, and a signal-to-noise ratio (SNR) is generally used as an index indicating the signal quality. Meanwhile, as the magnetic track width is smaller, the track density can be increased more, and a magnetic write width (MWW) is used as an index indicating the magnetic track width.

As a result of the study, it has been confirmed that a high recording density of no less than 3 Tb/in² can be expected under certain conditions when the configuration described in “Microwave Assisted Magnetic Recording” or “Media damping constant and performance characteristics in microwave assisted magnetic recording with circular as field” is adopted. In this study, the track width of a main pole of a recording head was 70 nm, which is sufficiently wider than the track width (40 nm) of an oscillator. Furthermore, it was assumed to use a magnetic recording medium having a configuration that is substantially the same as that described “Media damping constant and performance characteristics in microwave assisted magnetic recording with circular as field”, which has a grain size of 5 nm, an anisotropic magnetic field Hk of 30 kOe and an Hk dispersion of 5%, and having neither grain size dispersion nor dispersion of exchange coupling between grains.

However, it is not that actual mediums have neither grain size dispersion nor dispersion of exchange coupling between grains, but that actual mediums can be considered to have a dispersion of around 10 to 20%. Assuming the use of such actual mediums, a magnetic recording medium taking a grain size dispersion and an exchange coupling dispersion into consideration was used, which turned out that the recording density is substantially lowered. A main cause of the lowering is a substantial increase of the magnetic recording track width MWW to 58 nm from 40 nm, which is one before the consideration of the dispersion. The MWW increase is due to an increase in reversed magnetic field dispersion in the medium caused by the dispersions in the medium, and in order to reduce the MWW, it is effective to increase an effective magnetic field gradient in a cross-track direction.

The present invention is intended to provide a magnetic recording head and a magnetic recording apparatus, which are capable of providing both narrow track recording and a high recording density in microwave assisted recording using an oscillator that generates a high-frequency magnetic field.

In order to solve the aforementioned problems, the present invention uses a magnetic recording/reproduction apparatus including a magnetic recording medium that records magnetic information, an oscillator capable of applying a high-frequency magnetic field for promoting magnetization reversal of the magnetic recording medium, a recording head for recording a recording signal on the magnetic recording medium, and a reproduction head for reproducing the recording signal, based on the microwave assisted magnetic recording (MAMR) method.

A configuration of the oscillator is required to include a high-frequency magnetic field generation layer (FGL) that oscillates at a high frequency to apply a high-frequency magnetic field to the magnetic recording medium. The recording head is required to include a structure including a main pole for applying a recording magnetic field to a medium facing surface. The oscillator is arranged at a position adjacent to the main pole behind the main pole in a direction of advancement of the head viewed from the main pole, that is, on the trailing side. A shield can be provided in front of or behind, or both in front of and behind of the main pole in the direction of the advancement of the magnetic head. Furthermore, a side shield may be provided on one or both of outer sides in the track width direction of the main pole. A magnetic recording head including an oscillator in a magnetic recording/reproduction apparatus having the present configuration enables provision of a high recording density by decreasing the recording track width, by means of providing a proper relationship between track widths of mutually facing surfaces of the main pole and the oscillator at the position of an air bearing surface. More specifically, a track width Pw of a trailing edge of the main pole and a track width Two of a leading edge of the oscillator meet the following relationship:

0.85×Two<Pw<1.25×Two (1)

Furthermore, in the above configuration, in order to enhance the recording magnetic field strength, a track width at a position on the leading side of the main pole is made to be larger than the track width Pw of the trailing edge of the main pole. More specifically, the main pole has a shape represented by A and B below.

A. The main pole having a tapered shape in which the track width at the air bearing surface decreases from the leading side toward the position of the trailing edge adjacent to the oscillator.
B. The main pole having a protuberant shape in which the track width at the air bearing surface decreases from a predetermined position between a leading edge and the trailing edge toward the trailing edge.

Furthermore, in order to prevent erasure of data on adjacent tracks during recording in configurations A and B mentioned above, configuration C below can be provided.

C. The main pole having a shape in which the track width at the air bearing surface decreases from a predetermined position between the leading edge and the trailing edge toward the leading edge in configuration A or B above.

In configurations A, B and C above, the magnetic recording head can have configuration D below in order to increase a magnetic gradient in a down-track direction, and rotate the high-frequency magnetic field generation layer in an efficient direction according to the recording polarity.

D. The magnetic recording head including a trailing shield at a position adjacent to the oscillator on the trailing side relative to the oscillator. Furthermore, in the present configuration, a leading shield may be provided on the leading side relative to the main pole.

The magnetic recording head having configuration D above may include configuration E below in order to increase a magnetic gradient in the cross-track direction.

E. Configuration in which a side shield is provided on a side or each of two sides in the track width direction of the main pole.

According to the present invention, the track width of the leading edge of the oscillator and the track width of the trailing edge of the main pole are made to be substantially equal to each other, enabling a decrease in width of recording tracks. Furthermore, the main pole is made to have a shape in which the track width increases from the trailing edge toward the leading side, enabling enhancement of the recording magnetic field strength without causing an increase in the recording track width, and thus, enabling provision of a high linear recording density.

Problems, configurations and effects other than those described above will be clarified by the description of embodiments below.

### BRIEF DESCRIPTION OF THE DRAWINGS

FIG. 1 is a schematic diagram of a magnetic recording/reproduction head according to an embodiment of the present invention.

FIG. 2 is a schematic diagram illustrating an embodiment of a main pole, a trailing shield and an oscillator.

FIG. 3 is a schematic diagram illustrating an example of a main pole and an oscillator viewed from the medium facing surface side.

FIG. 4 is a schematic diagram illustrating a detailed example configuration of a recording head section.

FIG. 5 is a schematic perspective diagram illustrating an example of a main pole and an oscillator.

FIG. 6 is a diagram illustrating an optimum relationship between main pole width and oscillator width.

FIG. 7 shows a relationship between areal recording density and main pole width.

FIG. 8 is a schematic diagram illustrating another example of a main pole, a trailing shield and an oscillator.

FIG. 9 is a schematic diagram illustrating another example of a main pole and an oscillator viewed from the medium facing surface side.

FIG. 10 is a schematic diagram illustrating another example of a main pole and an oscillator viewed from the medium facing surface side.

FIG. 11 is a diagram illustrating a relationship between recording magnetic field strength and main pole width of a magnetic recording head.

FIG. 12 is a diagram illustrating a relationship between transition curvature and main pole width.

FIG. 13 is a schematic diagram illustrating another example of a main pole and an oscillator viewed from the medium facing surface side.

FIG. 14 is a schematic diagram illustrating another example of a main pole and an oscillator viewed from the medium facing surface side.

FIG. 15 is a schematic diagram illustrating another example of a main pole and an oscillator viewed from the medium facing surface side.

FIG. 16 is a schematic diagram illustrating another example of a main pole and an oscillator viewed from the medium facing surface side.

FIG. 17 is a schematic diagram illustrating another example of a main pole and an oscillator viewed from the medium facing surface side.

FIG. 18 is a schematic diagram illustrating another example of a main pole and an oscillator viewed from the medium facing surface side.

FIG. 19 is a schematic diagram illustrating another example of a main pole and an oscillator viewed from the medium facing surface side.

FIG. 20 is a schematic diagram illustrating another example of a main pole and an oscillator viewed from the medium facing surface side.

FIG. 21 is a schematic diagram illustrating another example of a main pole and an oscillator viewed from the medium facing surface side.

FIG. 22 is a diagram illustrating an example of a main pole, an oscillator, a trailing shield and side shields viewed from the medium facing surface side.

FIG. 23 is a diagram illustrating an example of a main pole, an oscillator, a trailing shield and a side shield viewed from the medium facing surface side.

FIG. 24 is a diagram illustrating an example of a main pole, an oscillator, a trailing shield and side shields viewed from the medium facing surface side.

FIG. 25 is a schematic diagram of a magnetic recording/reproduction apparatus.

### DETAILED DESCRIPTION OF THE PREFERRED EMBODIMENTS

Hereinafter, embodiments of the present invention will be described with reference to the drawings. For ease of understanding, parts having a same function are provided with a same reference numeral in the drawings.

### Embodiment 1

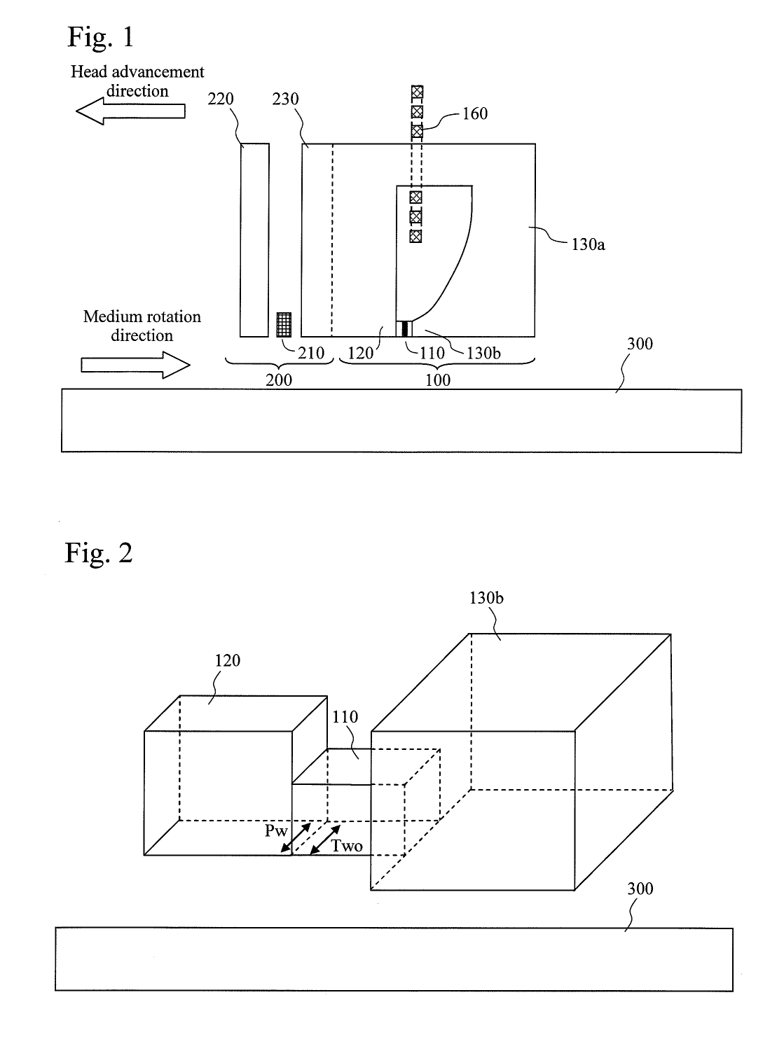

FIG. 1 is a schematic diagram of a magnetic recording/reproduction head according to an embodiment of the present invention. The magnetic recording/reproduction head is a recording/reproduction-separated head including a recording head section 100 and a reproduction head section 200. The recording head section 100 includes an oscillator 110 for generating a high-frequency magnetic field, a main pole 120 for generating a recording magnetic field, a coil 160 for exciting the main pole 120 to generate a magnetic field, and a sub-pole 130a. Furthermore, in the present embodiment, a trailing shield 130b is provided on the trailing side of the main pole, but is not essential. Here, it is defined that a trailing direction is a direction opposite to a direction of advancement of a head relative to a medium and a leading direction is a direction of advancement of a head relative to a medium. Also, although not illustrated in FIG. 1, a side shield may be provided on the outer side in a track width direction of the main pole 120. A side shield may be provided on each of two sides of the main pole 120, or may also be provided on one of the outer side and the inner side of the main pole 120 only. Furthermore, a magnetic recording medium 300 is illustrated for reference. In the present embodiment, the reproduction section 200 is arranged ahead and the recording section 100 is arranged behind viewed in a direction of advancement of the magnetic recording/reproduction head relative to the magnetic recording medium 300; however, a reversed configuration in which the recording section 100 is arranged ahead and the reproduction section 200 is arranged behind viewed from the direction of advancement of the head may be employed.

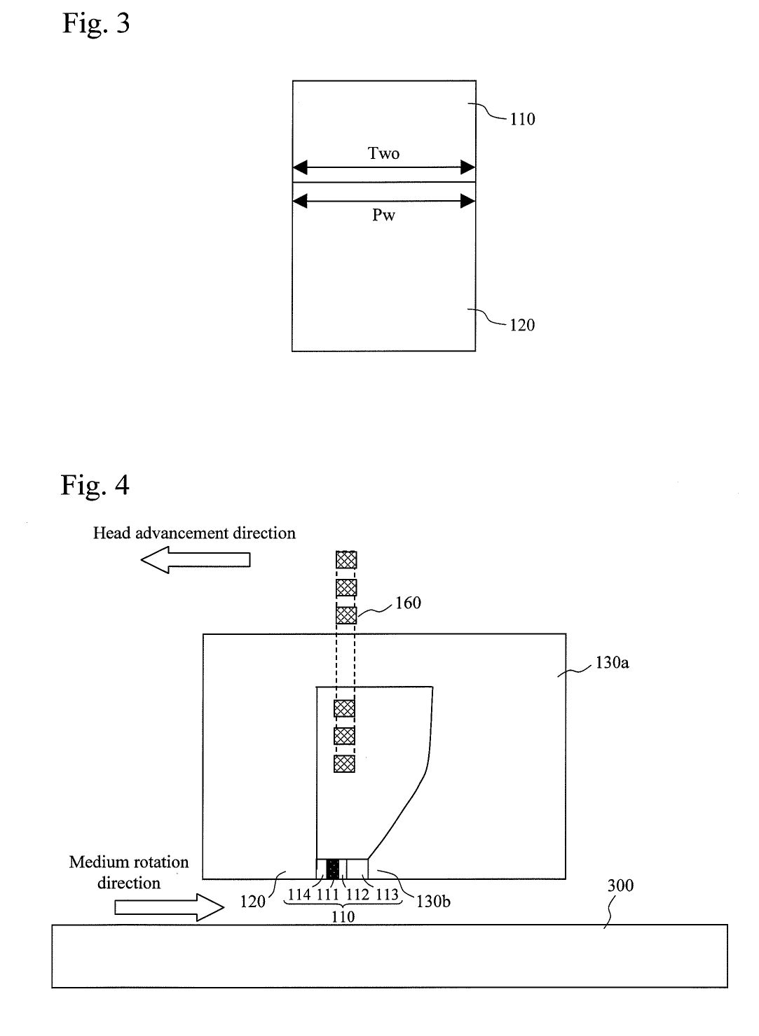

FIG. 2 is a schematic diagram illustrating the main pole 120 and the oscillator 110, which is a part of the recording section 100. FIG. 3 is a diagram of the main pole 120 and the oscillator 110 viewed from the side of surfaces of the main pole 120 and the oscillator 110 facing the medium. In FIG. 3, illustration of the trailing shield 130b is omitted. The present embodiment is characterized in that a track width Pw at an air bearing surface of an trailing edge of the main pole 120 and a track width Two at an air bearing surface of a leading edge of the oscillator 110 are substantially equal to each other and have the following relationship.

0.85×Two<Pw<1.25×Two (1)

A technical meaning and effects of the above numeral range will be described later.

The reproduction head section 200 has a structure in which a reproduction sensor 210 is sandwiched between a lower magnetic shield 220 and an upper magnetic shield 230. The reproduction sensor 210 is not specifically limited as long as the reproduction sensor 210 can serve to reproduce a recorded signal. The reproduction sensor 210 may be, for example, a reproduction sensor having what is called a giant magnetoresistive (GMR) effect, a reproduction sensor having a tunneling magnetoresistive (TMR) effect, or a reproduction sensor having an electromechanical resonant (EMR) effect. Alternatively, the reproduction sensor 210 may be what is called a differential reproduction sensor including two or more reproduction sensors that provide a reverse-polarity response to an external magnetic field. Also, it is preferable that the lower magnetic shield 220 and the upper magnetic shield 230 be provided for playing a significant role in enhancement of the reproduction signal quality.

FIG. 4 is a schematic diagram illustrating a further detailed example configuration of the recording head section 100. The oscillator 110 provided in the recording head section 100 includes an FGL 111 that generates a high-frequency magnetic field, an intermediate layer 112 including a material having high spin transmission, a spin torque transfer pinned layer 113 for providing a spin torque to the FGL 111, and a rotation guiding layer 114 for stabilizing magnetization rotation of the FGL. The configuration of the oscillator 110 may be obtained by stacking the rotation guiding layer 114, the FGL 111, the intermediate layer 112 and the spin torque transfer pinned layer 113 in this order from the main pole 120 side as illustrated in FIG. 4, or may be obtained by inversely stacking the spin torque transfer pinned layer 113, the intermediate layer 112, the FGL 111 and the rotation guiding layer 114 in this order from the main pole 120 side. The rotation guiding layer 114 is preferably provided from the perspective of the stability of oscillation of the FGL 111, but is not essential.

A material of the FGL 111 in the present embodiment is Fe₇₀ Co₃₀, and a thickness of the FGL 111 is 15 nm. Fe₇₀ Co₃₀ has a saturation magnetization of 2.4 T, and can generate a strong high-frequency magnetic field. For a material of the FGL 111, any magnetic material can serve as an FGL. Thus, the material may be, an NiFe alloy, an Heusler alloy such as CoFeGe, CoMnGe, CoFeA, CoFeSi, CoMnSi or CoFeSi, an Re-TM-based amorphous alloy such as TbFeCo or a CoCr-based alloy, other than an FeCo alloy. Alternatively, the material may be a material having negative vertical anisotropic energy such as Coin Whether the FGL 111 has a thickness of no less than or no more than 15 nm, the FGL 111 does not work against the scope and spirit of the present invention; however, the FGL 111 preferably has a thickness in the range of no less than 5 nm and no more than 30 nm. The setting of no less than 5 nm is made because an excessively small thickness results in a decrease in high-frequency magnetic field strength, and the setting of no more than 30 nm is made because an excessive large thickness results in FGL 111 having magnetic domains, causing a decrease in magnetic field strength.

The intermediate layer 112 in the present embodiment includes Cu and has a thickness of 2 nm. For a material of the intermediate layer 112, a nonmagnetic conductive material is preferable, and for example, Au, Ag, Pt, Ta, Ir, Al, Si, Ge or Ti can be used. The spin torque transfer pinned layer 113 in the present embodiment includes Co/Pt and has a thickness of 8 nm. Also, Co/Pt used in the present embodiment has a vertical anisotropic magnetic field Hk of 8 kOe. Use of a vertical anisotropic material for the spin torque transfer pinned layer 113 enables stable oscillation of the FGL 111, and it is preferable to use an artificial lattice magnetic material such as Co/Ni, Co/Pd or CoCrTa/Pd, for example, other than Co/Pt. Alternatively, although the stability of the oscillation somewhat deteriorates, a material similar to that of the FGL 111 can be used. The rotation guiding layer 114 in the present embodiment includes Co/Ni having vertical anisotropic energy and has a thickness of 8 nm. Also, Co/Ni in the present embodiment has a vertical anisotropic magnetic field Hk of 8 kOe. For the rotation guiding layer 114, it is preferable to use a material similar to that of the spin torque transfer pinned layer 113. The configuration of the oscillator 110 as described above enables application of a strong high-frequency magnetic field to a recording layer of the magnetic recording medium 300.

For the main pole 120, the sub-pole 130a and the shield 130b in the present embodiment, a CoFe alloy having a large saturated magnetization and almost no crystal magnetic anisotropy is used.

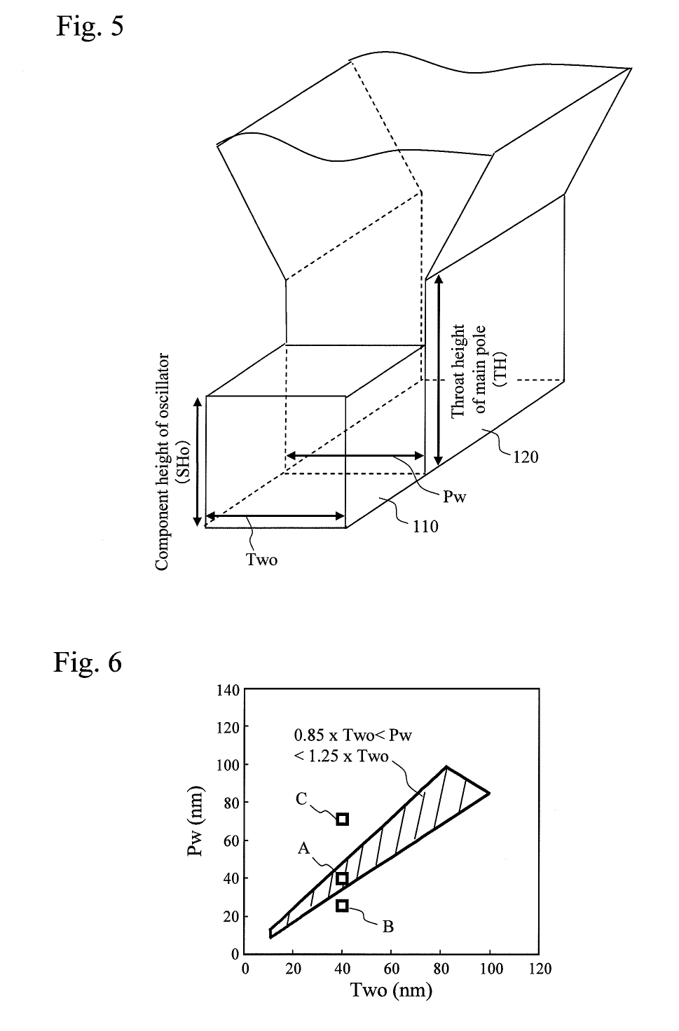

FIG. 5 is a schematic perspective diagram illustrating the main pole 120 and the oscillator 110. As described above, the track width of the oscillator 110 and the track width of the main pole 120 are substantially equal to each other, and are 40 nm in the present example configuration. Although a target value of a height (SHo) of the oscillator in a direction of a component height of the oscillator is 40 nm, the width can be determined so that a proper high-frequency magnetic field strength and a proper frequency can be obtained from the FGL. Also, a target value of a height (TH) (throat height) from the air bearing surface to a width increase start position of the main pole 120 is 60 nm. The height TH can be determined so that a proper recording magnetic field strength can be obtained. Furthermore, the degree of an increase in the track width of a part higher than TH viewed from the air bearing surface can also be set properly.

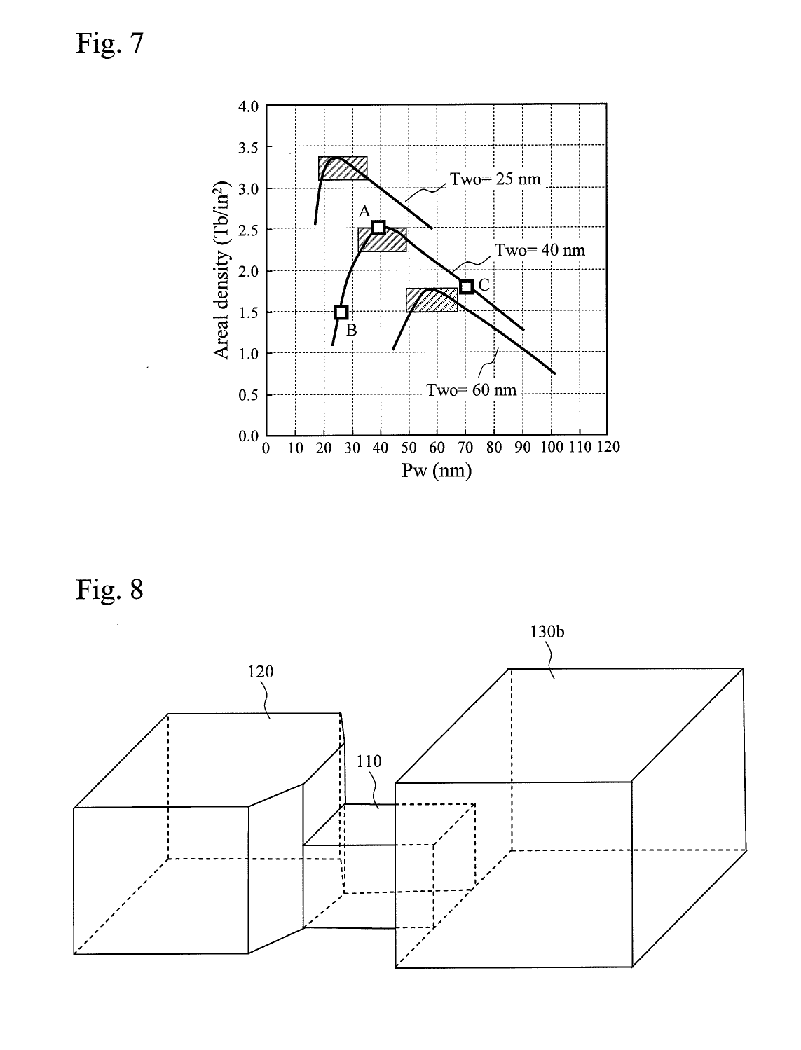

A range of an optimum relationship between the track widths Pw and Two at mutually facing surfaces of the oscillator 110 and the main pole 120, and effects obtained by setting the track widths Pw and Two in that range will be described with reference to FIGS. 6 and 7 and Table 1. Table 1 is a chart illustrating an oscillator width, a main pole width, an SNR, a linear recording density, a magnetic track width and an areal recording density of each of structures A, B and C, which will be described later.

TABLE 1

| | Structure A | Structure B | Structure C |
|---|---|---|---|
| Two (nm) | 40 | 40 | 40 |
| Pw (nm) | 40 | 25 | 70 |
| SNR (dB) | 13 | 0 | 14 |
| Linear density | 3900 | 2000 | 4100 |
| (kBPI) | | | |
| MWW (nm) | 40 | 36 | 57 |
| Areal density | 2.5 | 1.5 | 1.8 |
| (Tb/in²) | | | |

First, conditions for a head and a medium used in this study will be indicated. The track width Pw of the main pole 120 and the track width Two of the oscillator 110 at the air bearing surface are changed in the range of 10 to 120 nm. The throat height TH of the main pole 120 is changed depending on the track width Pw to a height 1.5 times the track width Pw. The component height (SHo) of the oscillator has a value equal to the track width Two. A material of the main pole 120 includes Fe₇₀ Co₃₀, and has a saturated magnetization of 2.4 T. A distance between the trailing shield 130b and the main pole 120 is 33 nm, which is equal to a sum of the thicknesses of the respective layers of the oscillator described above. The recording layer of the magnetic recording medium 300 has an anisotropic magnetic field Hk of 30kOe, a grain size of 5 nm and a thickness of 12 nm. Furthermore, a distance between the air bearing surfaces of the main pole 120 and the oscillator 110 and an uppermost surface of the recording layer of the magnetic recording medium 300 is 6 nm.

FIG. 6 illustrates an optimum Pw-Two relationship according to the present invention under the above conditions. It is only necessary that the Pw-Two relationship meets expression (1) above. FIG. 7 is a diagram illustrating a relationship between a realistic areal recording density and the track width Pw when the track width Two is maintained. Symbols A, B and C in FIGS. 6 and 7 correspond to structures A, B and C in Table 1. The track width Two in each of the structures A, B and C is 40 nm. Where Two is 40 nm, the areal recording density reaches a maximum value of 2.5 Tb/in² when Pw is 40 nm, which is equal to Two (structure A). However, where Pw is small such as 25 nm, the areal recording density is 1.5 Tb/in² (structure B), and where Pw is large such as 70 nm, the areal recording density is lowered to 1.8 Tb/in² (structure C). Assuming that a decrease of the areal recording density by around 10% from the maximum value of 2.5 Tb/in² can be allowed, where Two is 40 nm, the optimum range of Pw is in the range of no less than 85% and no more than 125% of Two.

Also, while FIG. 6 indicates only examples where Two is 40 nm, FIG. 7 illustrates a relationship between a realistic areal recording density and the track width Pw for each of additional cases where Two is 25 nm and Two is 60 nm. As can be seen from FIG. 7, where Two has a value other than 40 nm, also, the recording density reaches the maximum by making Two and Pw be substantially equal to each other. Accordingly, if Pw and Two can be maintained to have the relationship in expression (1), an optimum areal recording density can be provided according to the size of the track width Two. However, where Two or Pw is around no more than 10 nm, the strength of the high-frequency magnetic field from the oscillator 110 or the strength of the recording magnetic field from the main pole 120 is substantially decreased, and thus, saturated recording of a recording pattern cannot be performed and the recording density is substantially lowered, too. Therefore, it is necessary that Two and Pw be each around no less than 10 nm. Meanwhile, when Two or Pw is no less than 100 nm, the recording density is less than 1 Tb/in², and thus, only a small benefit can be provided for the existing vertical recording method and there is only a small advantage in employing the MAMR method. Accordingly, it is desirable that Two and Pw be no less than 10 nm and no more than 100 nm.

A reason that the areal recording density decreases where Two and Pw fall out of the relationship in expression (1) will be described with reference to Table 1, taking structures B and C as examples. Where Two is 40 nm and Pw is 25 nm in structure B, Pw and Two are largely different from each other, and thus, the SNR is largely decreased due to a decrease in effective magnetic field gradient in the cross-track direction and a decrease in recording magnetic field strength along with the decrease in Pw. Also, MWW is 36 nm, which is slightly smaller than that of the case where Pw is 40 nm. The amount of decrease in MWW is small compared to the decrease in geometric quantity of Pw from 40 nm to 25 nm. This is because a decrease in MWW of a magnetic recording medium having a real dispersion requires a decrease in both Pw and Two. Therefore, the recording density largely decreases when Pw has a value smaller than a value 0.85 times Two.

Next, a reason that the areal recording density decreases where Pw is larger than Two will be described taking structure C as an example. Where Two is 40 nm and Pw is 70 nm in the structure C, the recording magnetic field strength increases compared to the case where Pw is 40 nm, and thus, the SNR itself of the structure C is almost the same as that of structure A. However, as Pw is larger, MWW is also larger, and when Pw is 40 nm, MWW increases from 40 nm to 57 nm. As a result, the track density largely deteriorates while the linear recording density remains almost unchanged, causing deterioration in the areal recording density. Therefore, the recording density largely decreases also where Pw has a value larger than a value 1.25 times Two. Accordingly, Pw is made to have a dimension for maintaining expression (1) according to the value of Two, enabling provision of a magnetic recording/reproduction head that facilitates provision of a high areal recording density.

### Embodiment 2

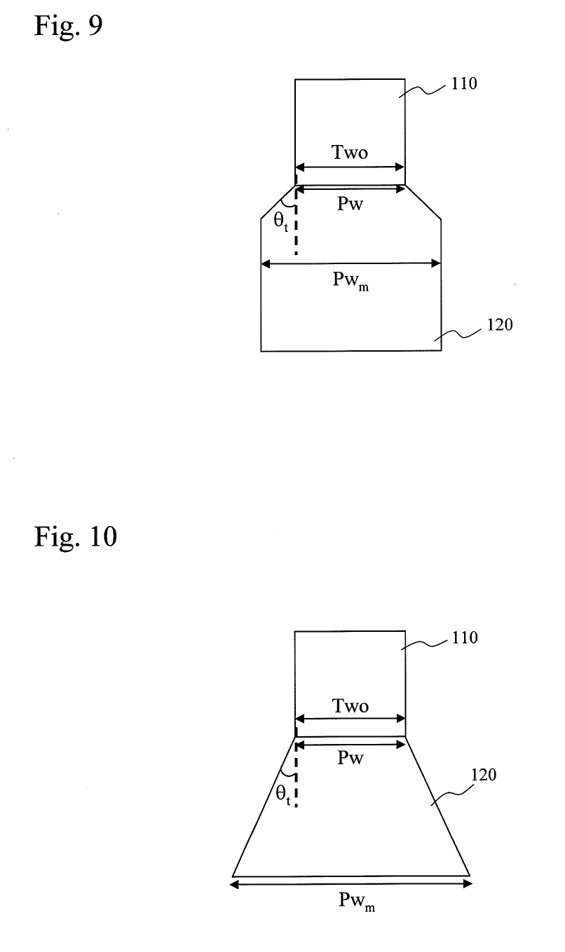

A second embodiment of the present invention will be described below. A configuration of the present embodiment is different from that of embodiment 1 only in a shape of a main pole 120 in a recording section 100. FIG. 8 is a schematic diagram of an oscillator 110, a main pole 120 and a trailing shield 130b in the present embodiment. Furthermore, FIG. 9 is a schematic diagram of the oscillator 110 and the main pole 120 in the present embodiment viewed from the air bearing surface side. In FIG. 9, illustration of the trailing shield 130b is omitted.

As in embodiment 1, in the present embodiment, a track width Pw at a trailing edge of a main pole 120 and a track width Two at a leading edge of the oscillator 110 are substantially equal to each other, viewed from the air bearing surface side, and have the relationship in expression (1). A characteristic of the present embodiment that is different from that of embodiment 1 lies in that the main pole 120 has a shape in which the track width increases from the trailing edge toward the leading side. Hereinafter, a maximum value of the track width at the air bearing surface of the main pole 120 is defined as Pwₘ. In a more specific example configuration, as illustrated in FIG. 9, the main pole 120 has a shape in which the track width increases from the trailing edge toward the leading side and reaches the maximum Pwₘ at a certain position, and the track width Pwₘ is maintained from the position where the track width reaches the maximum to the leading edge. Also, like the shape illustrated in FIG. 10, the track width may continuously increase from the track width Pw at the trailing edge until reaching the track width Pwₘ at the leading edge.

The configuration as described above enables enhancement in recording magnetic field strength without causing a substantial increase in MWW, enabling improvement in SNR and linear recording density.

Furthermore, in addition to the configuration, a geometric shape of the main pole 120 is made to have characteristics as indicated below, enabling provision of a large effect.

10°<θₜ<70° (2)

1.3<Pwₘ/Pw<3 (3)

Here, θₜ is an angle of tapering toward the trailing edge of the main pole 120 with respect to a head advancement direction. Where θₜ is larger than 70°, a large effect of a magnetic field from the tapered portion is provided, resulting in a large increase in MWW, and thus, it is desirable to set the angle θₜ to no more than 70°. Where θₜ is no more than 10°, there is only a small difference from a configuration provided with no tapered portion, and almost no magnetic field strength enhancement effect can be provided, and thus, it is preferable that θₜ is larger than 10°. Similarly, where Pwₘ/Pw is no more than 1.3, only a small effect can be provided in the tapering, and thus, it is preferable that Pwₘ/Pw be larger than 1.3. Meanwhile, even though Pwₘ/Pw is excessively large, no specific large problems arise in terms of characteristics, but where the difference between Pw and Pwₘ is increased to excess a threefold difference, there is an increase in dimensional errors in Pw in terms of manufacturing heads, and thus, it is preferable to set Pwₘ/Pw to less than 3. For example, in the case of the example configuration illustrated in FIG. 9, Pw is 40 nm, Pwₘ is 62 nm, Pwₘ/Pw is 1.6 and θₜ is 42°. In the example configuration illustrated in FIG. 10, Pw is 40 nm, Pwₘ is 82 nm, Pwₘ/Pw is 2.1 and θₜ is 25°. Accordingly, the configurations illustrated in FIGS. 9 and 10 each meet the conditions in expressions (2) and (3), and thus, enables enhancement in recording magnetic field strength without causing an increase in MWW.

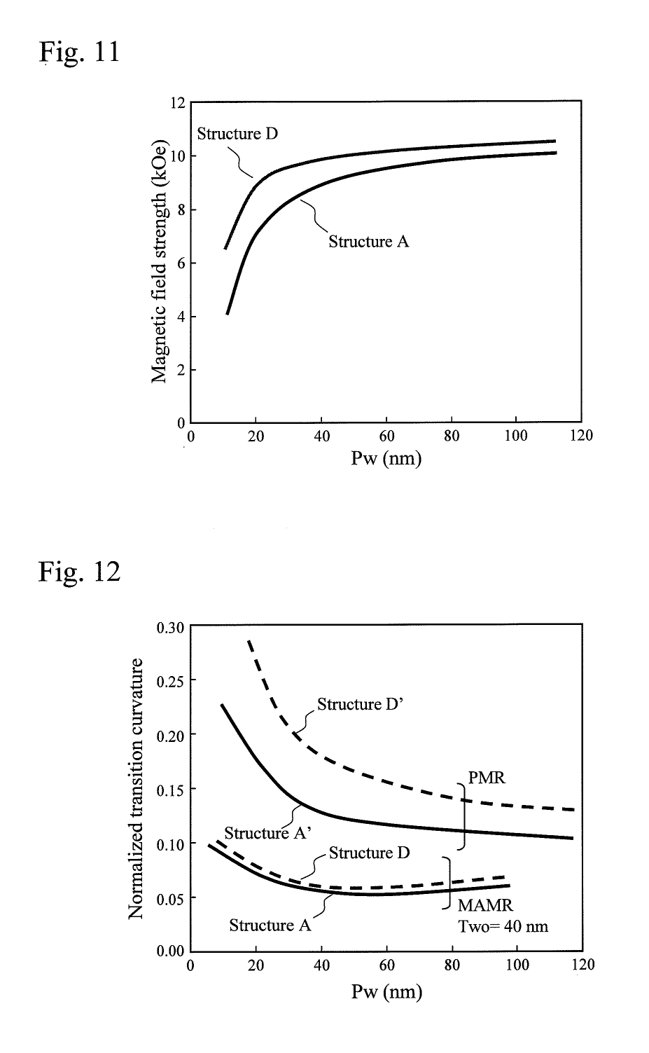

Next, details of effects provided by the present embodiment will be described with reference to Table 2 and FIGS. 11 and 12. The configurations illustrated in FIGS. 9 and 10 can provide effects substantially equivalent to each other, and thus, are collectively represented by structure D. Table 2 is a table illustrating an oscillator width, a main pole width, an SNR, a linear recording density, a magnetic track width and an areal recording density in each of structure A in embodiment 1 and structure D in the present embodiment.

TABLE 2

| | Structure A | Structure D | Structure E |
|---|---|---|---|
| Two (nm) | 40 | 40 | 30 |
| Pw (nm) | 40 | 40 | 30 |
| Pwm (nm) | 40 | 80 | 60 |
| SNR (dB) | 13 | 17 | 13 |
| Linear density | 3900 | 4500 | 3900 |
| (kBPI) | | | |
| MWW (nm) | 40 | 41 | 31 |
| Areal density | 2.5 | 2.8 | 3.2 |
| (Tb/in²) | | | |

As can be seen from Table 2, structure D in the present embodiment can provide an areal recording density higher than that of structure A in embodiment 1. This is because the SNR and the linear recording density can be improved without an increase in MWW.

As illustrated in FIG. 11, the improvement in SNR provided by structure D of the present embodiment is due to an increase in strength of a magnetic field from the main pole 120. The magnetic field strength is evaluated for a position at a center in a thickness direction of a recording layer of a medium. In the present embodiment, a distance between the air bearing surface of the main pole 120 and a surface of the recording layer of the medium is 6 nm and the thickness of the recording layer is 12 nm, and thus, the magnetic field strength illustrated in FIG. 11 indicates values for a point 12 nm away from the air bearing surface toward the medium.

Here, in ordinary recording methods not MAMR, there is no advantage in changing the shape of the main pole 120 from that of structure A to that of structure D, and the SNR deteriorates on the contrary. In reality, for the existing hard disk drive products, no magnetic recording heads including a main pole having a shape in which the track width increases from a trailing edge toward the leading side thereof are employed. This can be clarified considering a transition curvature. A transition curvature is an amount of a curve of a bit boundary line between recorded magnetizations. As the curve of the bit boundary line is smaller, only signal components that should be sensed during reproduction can be reproduced more, and thus, as the transition curvature is smaller, the recording density can be enhanced more. However, a magnetic field from the main pole 120 is stronger in a center of a track than an edge of the track, and thus, transition of bits in the center of the track occurs at a position away from the main pole while transition of bits in the track edge portion occurs at a position close to the main pole. In other words, a transition curvature of a recording pattern according to an equal-magnetic field curve of a magnetic field of the head occurs. FIG. 12 illustrates transition curvatures where recording is performed in each of the MAMR method and an ordinary recording method using each of structures A and D, which are different from each other in shape of the main pole 120.

FIG. 12 indicates ones having configurations according to an ordinary recording method (PMR), which are equal to those of structures A and D only in shape of the main pole as structures A′ and D′. It can be seen that in the ordinary recording method, structure D′ has a transition curvature larger than that of structure A′. Thus, an SNR of structure D′ deteriorates compared to that of structure A′. Meanwhile, in the MAMR method, the oscillator 110 is arranged adjacent to the main pole 120, and thus, the transition curvature is very small not depending on the curving of the equal-magnetic field curve of the magnetic field of the head, and thus, is substantially equal between structures A and D. Accordingly, structure D can further increase the magnetic field strength without causing an increase in transition curvature, compared to structure A, and thus, improve the SNR and the linear recording density.

### Embodiment 3

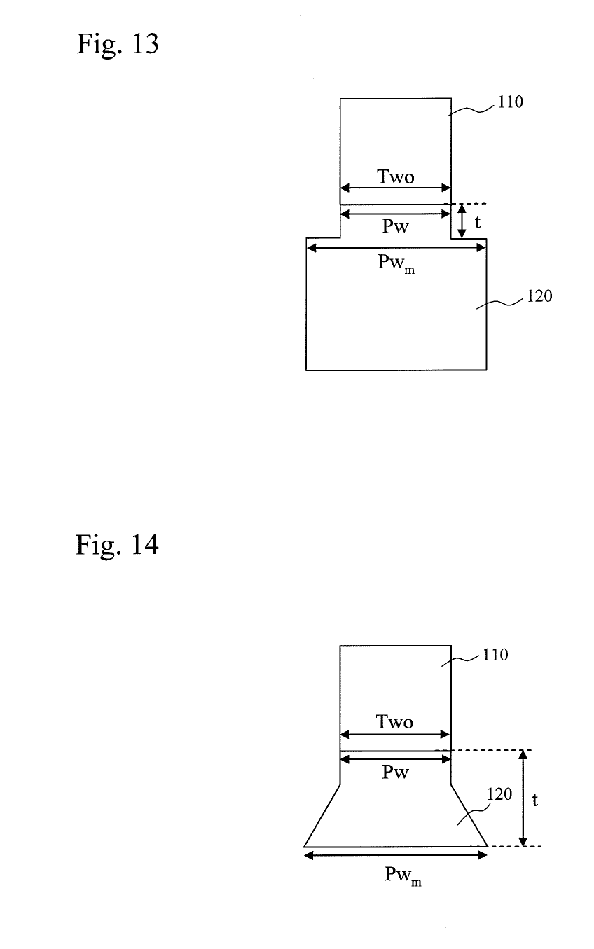

A third embodiment of the present invention will be described below. The present embodiment is different from embodiment 2 only in a shape of a main pole 120. As in embodiment 2, in the present embodiment, a track width Pw at a trailing edge of a main pole 120 and a track width Two at a leading edge of an oscillator 110 are substantially equal to each other, viewed from the air bearing surface side, and has the relationship in expression (1), and the track width on the leading side of the main pole 120 is larger than the track width Pw at the trailing edge of the main pole 120. FIGS. 13, 14 and 15 each illustrate a specific example configuration of the present embodiment. Although not illustrated in FIGS. 13, 14 and 15, a trailing shield 130b may be provided.

As illustrated in FIGS. 13, 14 and 15, a characteristic of the present embodiment lies in that a track width of the main pole 120 has a protuberant shape having a certain width maintained from the trailing edge toward the leading side in a certain area and an increased width from an end of the area toward the leading side when viewed from the air bearing surface side. In other words, θₜ in the configuration illustrated in embodiment 2 is substantially 0°. More specifically, the shape has a track width Pw maintained from the trailing edge to a predetermined position on the leading side and a track width increased from that position toward the leading side to a track width Pwₘ, which is larger than the track width Pw. Any of the configurations illustrated in FIGS. 13, 14 and 15 in the present embodiment provides effects substantially similar to those of the configuration illustrated in embodiment 2, and thus, a description of the effects will be omitted.

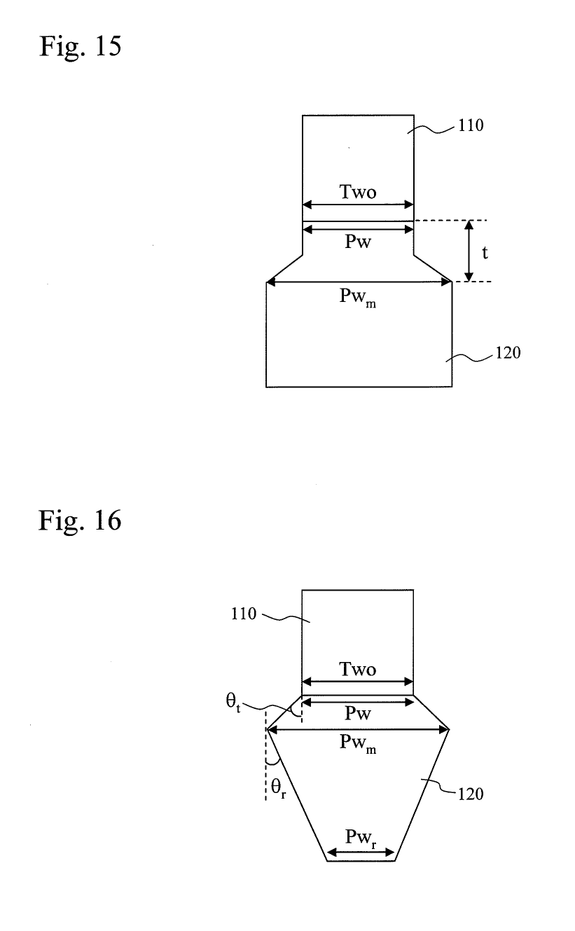

In the shape at an air bearing surface of the main pole illustrated in FIG. 13, a track width Pw is maintained from the trailing edge to a predetermined position on the leading side, and a track width Pwₘ resulting from the track width Pw sharply increasing at the predetermined position and maintained from the predetermined position to the leading edge. In the shape at the air bearing surface of the main pole illustrated in FIG. 14, a track width Pw is maintained from the trailing edge to a predetermined position on the leading side and the track width continuously increases from that position to the leading edge and ultimately reaches a maximum track width Pwₘ at the leading edge. In the shape at the air bearing surface of the main pole illustrated in FIG. 15, a track width Pw is maintained from the trailing edge to a predetermined position on the leading side, and the track width gradually increases from that position to another predetermined position on the leading edge to reach a maximum track width Pwₘ, which is maintained from that other predetermined position to the leading edge.

In order to sufficiently provide the effects of the present embodiment, it is preferable that the shapes illustrated in FIGS. 13, 14 and 15 each meet the following relationship.

1.3<Pwₘ/Pw<3 (3)

0.2<t/Pw<2 (4)

Here, a reason for the necessity to meet expression (3) is the same as that of embodiment 2, and thus, a description of the reason will be omitted. The symbol “t” in expression (4) indicates a distance in a head advancement direction from the trailing edge to a position in which the track width reaches Pwₘ, which is a maximum value of the main pole width. Where t/Pw is no more than 0.2, a magnetic field from the position where the main pole width is larger than Pw has too much effect, causing in a substantial increase in MWW, and thus, it is preferable that t/Pw be larger than 0.2. Meanwhile, where t/Pw is no less than 2, the effect of magnetic field strength enhancement at a position of the boundary between the main pole 120 and the oscillator 110 where magnetization transition is formed is substantially decreased, and thus, it is preferable that t/Pw be smaller than 2.

Example geometrical dimensions of each of the configurations illustrated in FIGS. 13, 14 and 15 will be indicated below. In an example of dimensions preferable for the configuration illustrated in FIG. 13, Pw is 40 nm, Pwₘ is 68 nm, Pwₘ/Pw is 1.7, t is 12 nm and t/Pw is 0.3. In an example of dimensions preferable for the configuration illustrated in FIG. 14, Pw is 40 nm, Pwₘ is 67 nm, Pwₘ/Pw is 1.7, t is 31 nm and t/Pw is 0.8. In an example of dimensions preferable for the configuration illustrated in FIG. 15, Pw is 40 nm, Pwₘ is 67 nm, Pwₘ/Pw is 1.7, t is 22 nm and t/Pw is 0.6. Each of the configurations in FIGS. 13, 14 and 15 having the respective dimensions above meets expressions (3) and (4), enabling enhancement of the magnetic field strength without causing a substantial increase in MWW.

### Embodiment 4

A fourth embodiment of the present invention will be described below. The present embodiment is different from embodiments 2 and 3 only in a shape of a main pole 120. As in embodiments 2 and 3, in the present embodiment, a track width Pw at a trailing edge of the main pole 120 and a track width Two at an air bearing surface of a leading edge of an oscillator 110 are substantially equal to each other, viewed from the air bearing surface side, the relationship in expression (1) is met, and the main pole 120 includes a part having a track width larger than the track width Pw at a position on the leading side relative to the trailing edge of the main pole 120. FIGS. 16 to 21 illustrate specific example configurations of the present embodiment. Although not illustrated in the Figures, a trailing shield may be provided.

A characteristic of the present embodiment lies in that the main pole 120 has a shape in which a track width Pwᵣ at a leading edge increases toward the trailing side to reach a track width Pwₘ, viewed from the air bearing surface side. Such configuration provides a decrease in magnetic field leakage from the main pole 120 to adjacent tracks in addition to the effects of embodiments 2 and 3, enabling the effect of preventing erasure of recorded magnetizations on the adjacent tracks. Compared to the configurations in embodiments 2 and 3, in the present embodiment, the area of the main pole itself is small, and thus, the recording magnetic field strength is somewhat decreased; however, erasure of recorded magnetizations on the adjacent tracks can be prevented, making it easy to increase the track density and thus increase the areal recording density as a whole. The configurations of the present embodiment illustrated in FIGS. 16 to 21 each enable provision of effects substantially equal to each other.

Next, the details of the shapes of the main pole 120 illustrated in FIGS. 16 to 21 will be described. In each of the configurations, it is defined that Pw is a track width of a trailing edge at an air bearing surface of the main pole 120, Pwₘ is a track width that reaches a maximum at a certain position between the trailing edge and a leading edge, and Pwᵣ is a track width of the leading edge.

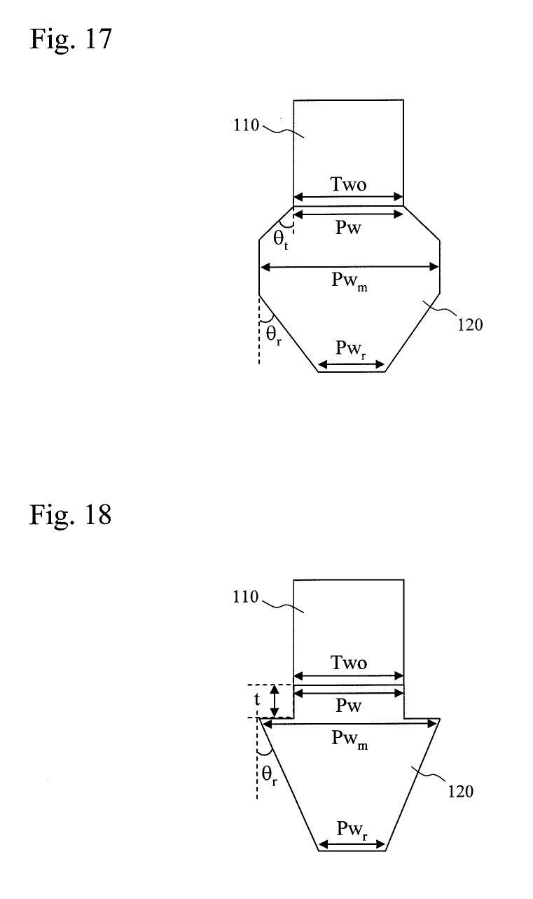

In each of the main pole shapes illustrated in FIGS. 16 and 17, the track width Pw at the trailing edge increases to reach the track width Pwₘ at a certain position on the leading side, and the shape on the trailing side is close to that of the configuration illustrated in embodiment 2. In the configuration in FIG. 16, the track width decreases toward the leading edge immediately from the position where the track width reaches Pwₘ from Pw. In the example configuration illustrated in FIG. 17, there is an area in which the track width Pwₘ is substantially maintained, and the track width decreases from the area toward the leading edge to reach the track width Pwᵣ at the leading edge.

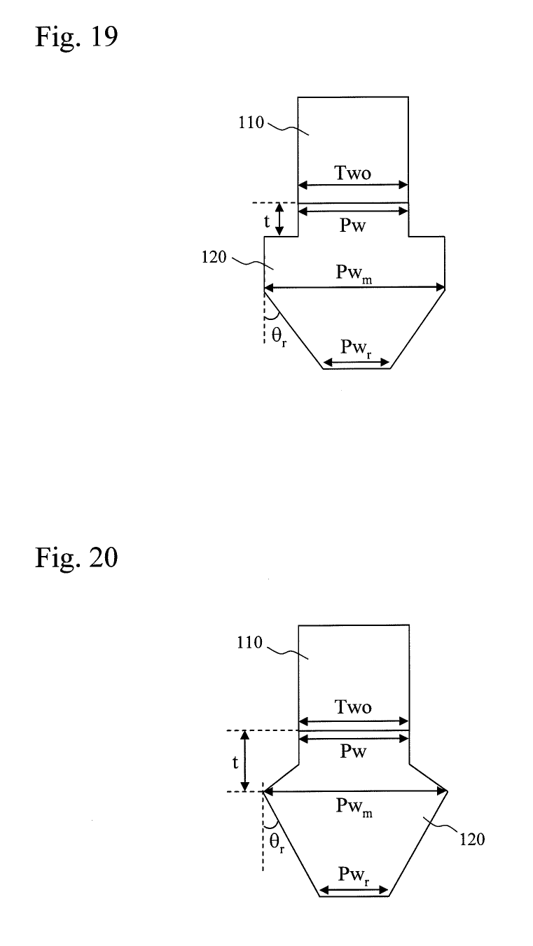

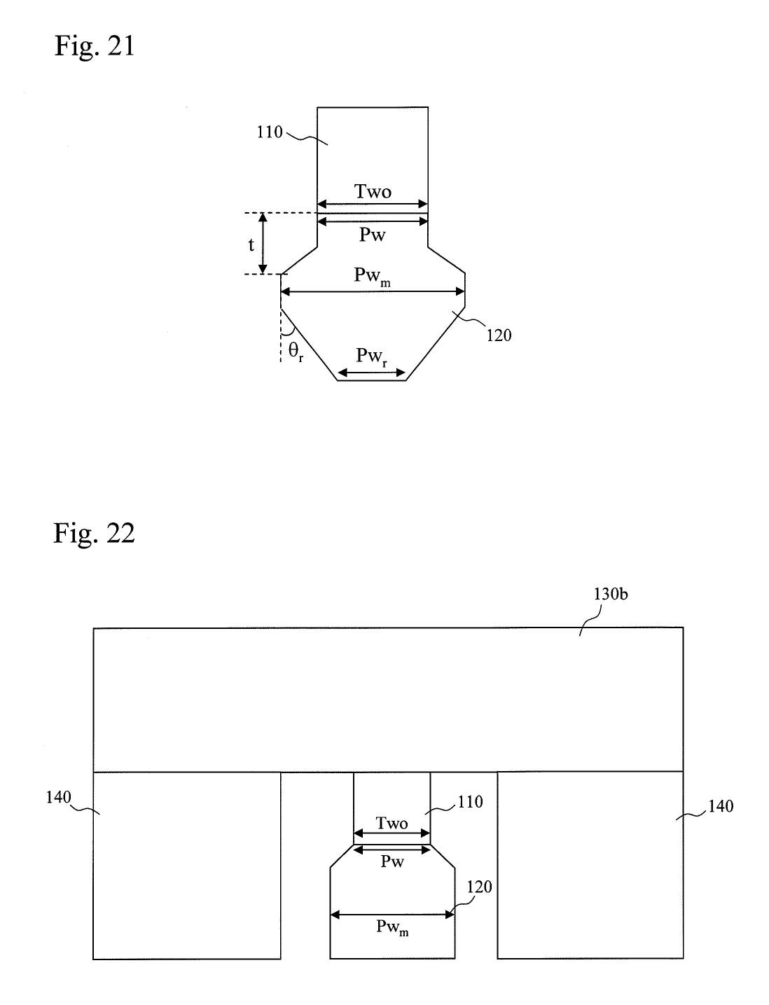

Meanwhile, each of the example configurations illustrated in FIGS. 18, 19, 20 and 21 has a protuberant shape in which the track width Pw is maintained from the trailing edge to a predetermined position on the leading side and the track width increases from the predetermined position, and the shape on the trailing side is close to that of embodiment 3. In the configuration in FIG. 18, the track width decreases toward the leading edge immediately from a position where the track width reaches a maximum value Pwₘ. In the configuration in FIG. 19, there is an area in which the track width is substantially maintained at Pwₘ, and the track width decreases from the area toward the leading edge. In each of the configurations in FIGS. 20 and 21, there is an area in which a track width gradually increases from Pw to Pwₘ from the trailing side toward the leading side. A difference between the configurations in FIGS. 20 and 21 lies in that the configuration in FIG. 20 has a shape in which the track width decreases toward the leading edge immediately from the position where the track width reaches the maximum value of Pwₘ, while the configuration in FIG. 21 has a shape in which there is an area where the track width Pwₘ is substantially maintained, and the track width decreases from the area toward the leading edge.

In order to sufficiently provide the effects of the present embodiment, it is preferable that each of the shapes illustrated in FIGS. 16 to 21 meet the following relationship.

(Condition A) Where θₜ≠0°,

10°<θₜ<70° (2)

1.3<Pwₘ/Pw<3 (3)

5°<θᵣ<60° (5)

Pwᵣ/Pw_{m<0.7} (6)

(Condition B) Where θᵣ≈0°,

1.3<Pwₘ/Pw<3 (3)

0.2<t/Pw<2 (4)

5°<θᵣ<60° (5)

Pwᵣ/Pwₘ<0.7 (6)

Here, θᵣ is an angle of the width of the main pole 120 relative to a head advancement direction at a position where the width of the main pole 120 starts decreasing from Pwₘ toward the leading edge. Where θᵣ is less than 5°, the effect of reduction of magnetic field leakage to adjacent tracks is not sufficient, and thus, it is preferable that θᵣ be larger than 5°. Meanwhile, where θᵣ is larger than 60°, errors in geometrical dimensions of Pwₘ and Pwᵣ in manufacturing heads are increased, and thus, it is preferable that θᵣ be less than 60°. As long as expression (5) is met, a lower limit of Pwᵣ may be zero; however, where Pwᵣ/Pwₘ is no less than 0.7, a sufficient effect of reduction of magnetic field leakage to adjacent tracks cannot be obtained, and thus, it is preferable to set Pwᵣ/Pwₘ to less than 0.7.

The configurations illustrated in FIGS. 16 and 17 each fall under the case of condition A, and thus, it is only necessary that expressions (2), (3), (5) and (6) be met. Meanwhile, the configurations illustrated in FIGS. 18 to 21 each fall under the case of condition B, and thus, it is only necessary that expressions (3), (4), (5) and (6) be met.

Example dimensions will be described. In the example configurations illustrated in FIGS. 16 to 21, Pw, Pwₘ and Pwᵣ, which are equal among the configurations, are 40 nm, 65 nm and 25 nm, respectively, and thus, expressions (3) and (6) are met. θₜ in each of the example configurations illustrated in FIGS. 16 and 17 is 24°, θᵣ in the example configuration illustrated in FIG. 16 is 23°, θᵣ in the example configuration illustrated in FIG. 17 is 35°, and thus, expressions (2) and (5) are met. Among the example configurations illustrated in FIGS. 18 to 21, t is 12 nm and t/Pw is 0.3 in each of the example configurations in FIGS. 18 and 19, and t is 22 nm and t/Pw is 0.6 in each of the example configurations in FIGS. 20 and 21, and thus, each of the example configurations meets expression (4). In the example configurations in FIGS. 18 to 21, θᵣ is 23°, 35°, 28° and 35°, respectively, and thus, expression (5) is met.

Each of the configurations described above enables provision of a magnetic recording/reproduction head capable of enhancing a strength of a magnetic field from a main pole 120 while recording on narrow tracks, and preventing erasure of signals on adjacent tracks.

### Embodiment 5

A fifth embodiment of the present invention will be described below. FIG. 22 is a schematic diagram of a recording head according to the present embodiment, viewed from the air bearing surface side. In the present embodiment, a main pole and an oscillator each have a shape that is the same as that of embodiment 2. Embodiment 5 is different from embodiment 2 in that side shields 140 are provided on the outer side in a track width direction of the main pole 120. It should be noted that the side shields 140 may be provided in each of the configurations of embodiments 1, 3 and 4 other than the configuration of embodiment 2. The provision of the side shields 140 enables an increase in gradient in the track width direction of a magnetic field from the main pole 120 and an oscillator 110, prevention of spread of write during recording, and an increase in track density.

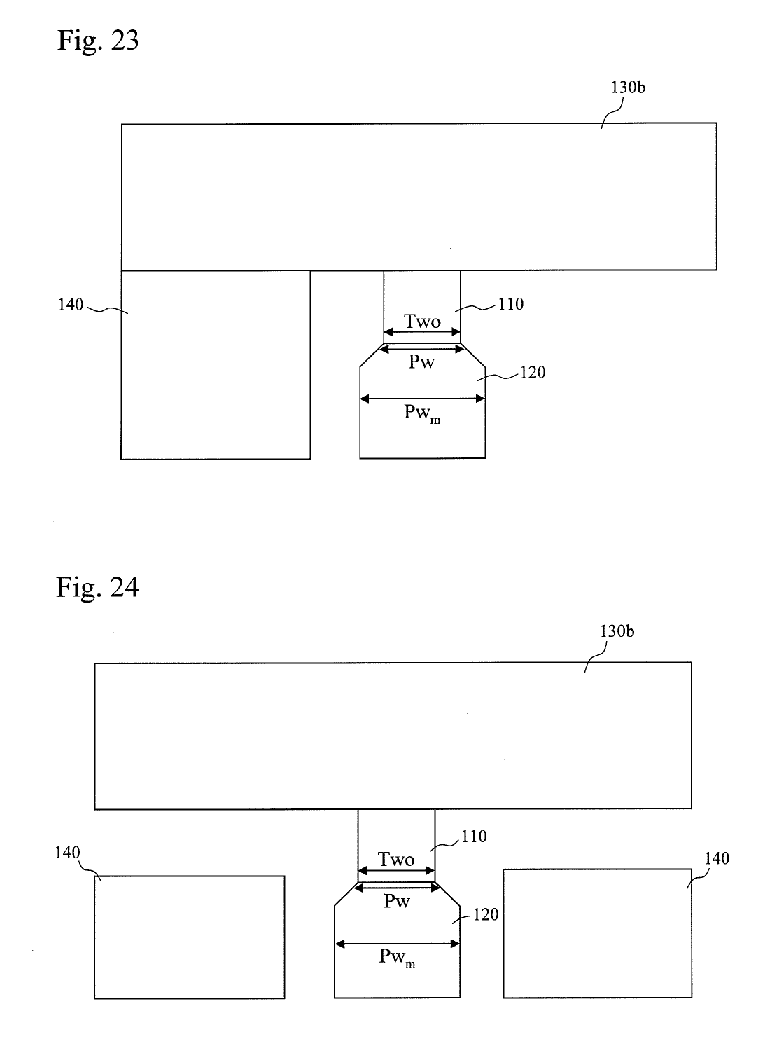

A side shield 140 may be provided on each of opposite sides in the track width direction of the main pole 120 as illustrated in FIG. 22, or may also be provided only on either one side in the track width direction as illustrated in FIG. 23. The configuration in which a side shield 140 is provided only on one side in the track width direction of the main pole is effective in what is called shingle recording in which recording is performed in one direction with edge portions in the track width direction overlapping one another in a radial direction of a magnetic recording medium. Furthermore, in these configurations, the side shield(s) 140 and the trailing shield 130b are in contact with each other; however, this is not essential.

Furthermore, as illustrated in FIG. 24, it is also possible that side shields 140 are provided only on the outer sides in the track width direction of the main pole 120, and no shields are provided on the outer sides in the track width direction of the oscillator 110. In this case, the gradient in the track width direction of a high-frequency magnetic field from the oscillator 110 deteriorates, but a strength itself of the high-frequency magnetic field from the oscillator 110 is enhanced, and thus, embodiment 5 is effective especially where recording is performed on a medium that is hard to perform recording thereon because of its large anisotropic magnetic field Hk.

### Embodiment 6

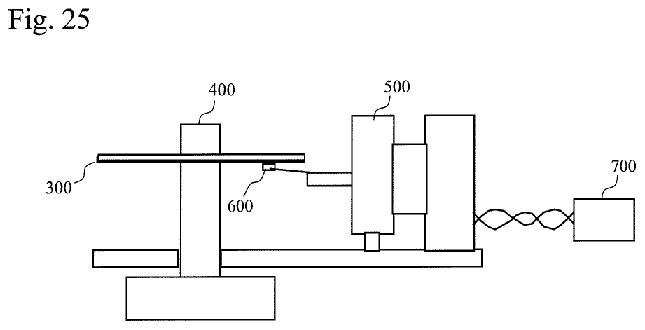

A sixth embodiment of the present invention will be described below. FIG. 25 is a conceptual diagram illustrating an example configuration of a magnetic recording/reproduction apparatus including a magnetic recording head according to the present invention. The magnetic recording head may be one according to any of embodiments 1 to 5, and mounted on a head slider 600.

In the magnetic recording/reproduction apparatus illustrated in FIG. 25, a magnetic recording medium 300 is rotated by a spindle motor 400, and the head slider 600 is guided to a desired track of the magnetic recording medium 300 by an actuator 500. In other words, in a magnetic disk apparatus, a reproduction head and a recording head provided on the head slider 600 approach a predetermined recording position of the magnetic recording medium 300 by means of the aforementioned mechanism and move relative to each other to sequentially write/read signals. The actuator 500 is desirably is a rotary actuator. The magnetic recording medium 300 may be what is called a continuous media in which respective bits continuously exist or what is called a discrete track media including a non-magnetic area, in which write cannot be performed by a recording head, between tracks. Alternatively, the magnetic recording medium 300 may be what is called a patterned media including a nonmagnetic material filling a recess portion between protruding magnetic patterns on a substrate thereof. A recording signal is recorded on the medium by the recording head through a signal processing system 700, and an output of the reproduction head is obtained as a signal through the signal processing system 700. Furthermore, when moving the reproduction head to a desired recording track, a position on a track of the reproduction head can be detected using a highly-sensitive output from the reproduction head to control the actuator such that the head slider is positioned. Although the present Figure illustrates one head slider 600 and one magnetic recording medium 300, a plurality of head sliders 600 and a plurality of magnetic recording mediums 300 may be provided. Furthermore, the magnetic recording medium 300 may have a magnetic recording layer on each of opposite sides thereof to record information thereon. Where information is to be recorded on each of opposite sides of a disk, the head slider 600 is arranged on each of the opposite sides of the magnetic recording medium 300.

It should be noted that the present invention is not limited to the above-described embodiments and includes various alterations. For example, the above-described embodiments have been described in detail to describe the present invention in an understandable manner, and the present invention is not necessarily limited to those including all of the components described above. Also, a configuration of an embodiment can partly be substituted with a configuration of another embodiment, and a configuration of an embodiment can be added to a configuration of another embodiment. Furthermore, a part of a configuration of each embodiment can be obtained by adding or deleting a configuration of another configuration or substituting the part of the configuration with the configuration of the other configuration.

### DESCRIPTION OF SYMBOLS

100: recording section
110: oscillator
111: high-frequency magnetic field generation layer (FGL)
112: intermediate layer
113: spin torque transfer pinned layer
114: rotation guiding layer
120: main pole
130a: sub-pole
130b: trailing shield
140: side shield
160: coil
200: reproduction section
210: reproduction sensor
220: lower magnetic shield
230: upper magnetic shield
300: magnetic recording medium
400: spindle motor
500: actuator
600: head slider
700: recording signal processing system

What is claimed is:

1. A magnetic head comprising:
a main pole that generates a recording magnetic field; and
an oscillator provided adjacent to the main pole on a trailing side of the main pole, the oscillator generating a high-frequency magnetic field,
wherein a track width Pw at an air bearing surface of a trailing-side edge portion of the main pole and a track width Two at an air bearing surface of an edge portion on the main pole side of the oscillator meet the relationship:
0.85×Two<Pw<1.25×Two.

2. The magnetic head according to claim 1, wherein the main pole includes a part having a track width at the air bearing surface, the track width being larger than the track width Pw, between the trailing-side edge portion and a leading-side edge portion of the main pole.

3. The magnetic head according to claim 2, wherein the main pole includes an area having a track width at the air bearing surface, the track width gradually increasing from the trailing-side edge portion toward a leading side.

4. The magnetic head according to claim 2, wherein the main pole includes a part having a track width at the air bearing surface maintained to be Pw only in a predetermined area from the trailing-side edge portion toward a leading side, and made to be larger than the track width Pw from an end of the predetermined area.

5. The magnetic head according to claim 2, wherein the main pole includes a part having a track width at the air bearing surface, the track width being larger than the track width of the leading side edge portion, between the trailing-side edge portion and the leading-side edge portion of the main pole.

6. The magnetic head according to claim 1, comprising a trailing shield on the trailing side of the main pole, wherein the main pole, the oscillator and the trailing shield are arranged in this order from the leading side to the trailing side.

7. The magnetic head according to claim 1, comprising a side shield on a side or each of two sides in a cross-track direction of the main pole.

8. The magnetic head according to claim 1, further comprising a pair of magnetic shields, and a reproduction sensor arranged between the pair of magnetic shields.

9. A magnetic recording/reproduction apparatus comprising:
a magnetic recording medium;
a medium drive section that drives the magnetic recording medium;
a magnetic head that reads/writes information from/to the magnetic recording medium; and
a head drive section that positions the magnetic head on a desired track of the magnetic recording medium,
wherein a magnetic head according to claim 7 is used for the magnetic head.
